(19) United States
(12) Patent Application Publication
(10) Pub. No.: US 2006/0159128 A1
(43) Pub. Date: Jul. 20, 2006

(54) Channel switching subscription service according to predefined content patterns

(76) Inventors: Yen-Fu Chen, Austin, TX (US); John Hans Handy-Bosma, Cedar Park, TX (US); Keith Raymond Walker, Austin, TX (US)

Correspondence Address: IBM CORPORATION (RHF), C/O ROBERT H. FRANTZ, P. O. BOX 23324, OKLAHOMA CITY, OK, 73123, US

(21) Appl. No.: 11/039,511

(22) Filed: Jan. 20, 2005

(51) Int. Cl. H04H 1/04

(52) U.S. Cl. 370/486

(57) ABSTRACT

A monitor service which monitors the content of a plurality of broadcast channels, and characterizes the content of the broadcast programs, operatively coupled to an evaluator which considers the content of broadcast programs over time compared to a personal channel control schema, and further cooperating with a channel change commander to effect changes in channel, signal source, or both, of an enhanced broadcast receiver so as to allow a user to view content from a plurality of sources and channels in real-time according to his or her preferences, whilst automatic changes in the channels and signal sources are made.

### BACKGROUND OF THE INVENTION

1. Field of the Invention

This invention relates to technologies for automatically selecting channels and signal sources in a broadcast receiver.

2. Background of the Invention

Consumers have a wide variety of broadcast sources, channels, receivers, and viewing devices today, including, as shown in FIG. 1 (100):
(a) sources of programming or content (10), including optional Secondary Audio Program (“SAP”) and closed captioning (14);
(b) transmission and reception media including geosynchronous (“GS”) satellite (6, 5, 4, 3) signals, local or “off air” signals (7, 8, 9, 11), cable (12, 13), and more recently “webcasts” via cable modem (14) or Digital Subscriber Line (“DSL”) signals over Public Switched Telephone Network (“PSTN”) lines and the Internet (15); and
(c) decoding, recording, and presentation devices such as cable decoders, video recorders, Digital Versatile Disk (“DVD”) players/recorders, TV television and High Definition Television (“HDTV”) tuners, as well as Internet video players (e.g. Apple's QuickTime, Microsoft's Mediaplayer, etc.).

Personal Video Recorders (“PVR”), Digital Video Recorders (“DVR”), and other TV, computer and multimedia hub devices are rapidly gaining popularity and opening new markets for service provision. With so many sources of signals (e.g. satellite, cable, ‘off air’ or antenna, etc.) and so many channels, many viewers constantly “channel surf” trying to watch two or more broadcast programs simultaneously. A few years ago, picture-in-picture televisions attempted to alleviate this problem, but this solution has only found partial acceptance in the marketplace.

DVR's aim to address a portion of the problem, especially with a problem of real-time playback, wherein the DVR can be recording in real-time, but the viewer can pause the playback to get a snack, check another channel, etc., all whilst the recording process continues so that the viewer will not actually miss any action, albeit in non-realtime or delayed playback.

“Short segment content patterns” are categories of portions of broadcast programs and shows that have value out of the context of the broadcast. For example, a single news item can be appreciated without watching the rest or the entirety of the news broadcast. Similarly, portions of a sports broadcast can be appreciated without watching the entire event, evidence of which is the popularity of “highlight” shows such as ESPN's Sports Center.

Currently someone who is interested in specific short-segment content types must manually switch channels when the current content no longer suits their preference, such as during a commercial, during a lull in the action, or when the broadcast changes topics. Take the example of a baseball fan trying to watch baseball games on a Saturday afternoon. There may be four or five games on TV. When the fan's game of primary interest goes to commercial, the fan uses their remote control to change channels to another broadcast. They might use picture-in-picture to be reminded when their primary game is back on. If the first channel they flip to is likewise on a commercial, they have to change the channel yet again, and so on until they find a channel to pass the time. If the fan wants to spend the commercial time flipping through the other four games to get current scores, the fan has to remember the channel numbers and spend time keying them in, potentially running into commercials or broadcasts where the score is not currently displayed.

None of the features offered by picture-in-picture televisions and monitors, nor in the new DVR units actually addresses this problem. Therefore, there is a need in the art for a system and service which automatically changes “channels”, including changing signal sources when appropriate, based on predefined short segment content patterns and according to a user's preferences. The user's preferences should define an order of precedence so that when two or more programs have content that is good or interesting to the user, the technology has the logic and conditions necessary to pick a preferred channel and/or signal source.

### BRIEF DESCRIPTION OF THE DRAWINGS

The following detailed description when taken in conjunction with the figures presented herein present a complete description of the present invention.

FIG. 1 illustrates the many sources from which a broadcast receiver can receive signals, channels, and programs.

FIG. 2 shows a generalized view of the architecture of a Digital Video Recorder.

FIGS. 3a and 3b depict the interrelationships between the monitoring service of the invention and the various programming and content sources of FIG. 1.

FIG. 4 provides more details of the monitoring service according to the invention.

FIG. 5 provides an example of an advisory message.

FIG. 6 illustrates at a high level the logic of the present invention.

FIG. 7 provides an example of a change-channel command.

FIG. 8 depicts an enhancement of a DVR to include some or all of the logic of the present invention.

FIG. 9 illustrates more details of the logical process of the present invention.

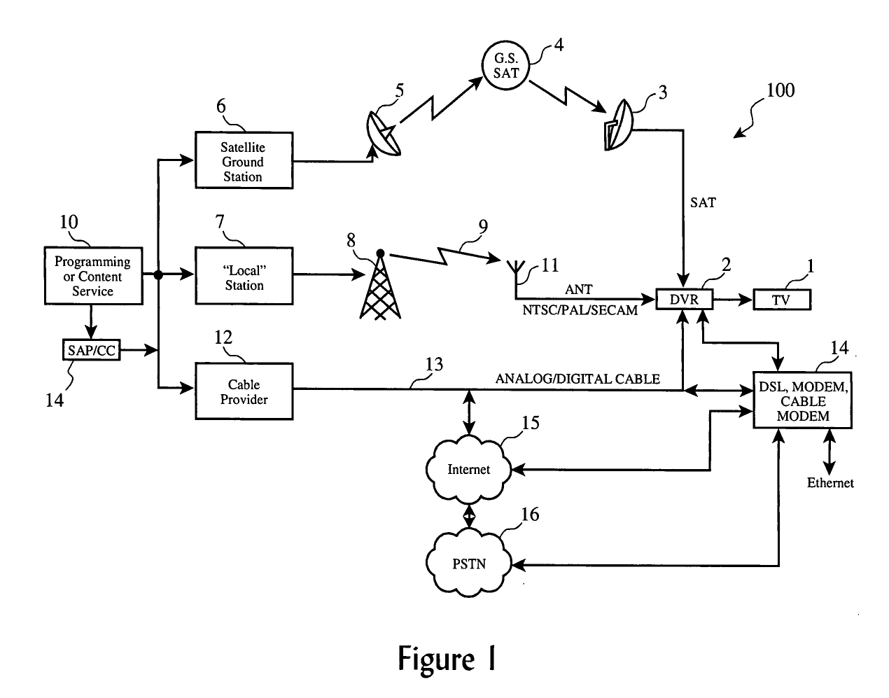

### SUMMARY OF THE INVENTION

Our invention includes a short segment monitoring service, a messaging service to alert enhanced tuners to changes in channel content, and a channel switching technology to implement channel switches according to received messages from the monitoring service according to a user's preferences. As such, our invention provides a new technology and service for channel switching based on predefined short segment content patterns.

Some examples of category types include baseball, baseball action (to avoid pauses between pitches), all sports, international news, local news, traffic, standup comedy, etc. Using our invention allows user to watch, for example, two or three baseball games, just getting the main action from each game. The user defines the order of precedence so that when two or more programs have content that is good, the service knows to stick with the current channel, or to switch to a channel with content having even greater interest to the user.

So, for example, a Cleveland Indians baseball fan can watch all of the action in that game, and only be switched over to a Houston Astros baseball game during pauses in the Indians game.

The present invention also lends itself well to special events where there is a massive audience, such as the Olympics, for which a user can specify they want to be brought to the Olympics broadcast only when a specific event is being broadcast, such as when swimming coverage is being broadcast.

In more advanced implementations of the present invention, keyword indices are used to increase category choice, such as election news, breaking news story, and the like.

The present invention provides two distinct advantages to the existing manual methods of “channel surfing”:
(a) the invention can switch among broadcasts faster and more reliably than a user can; and
(b) the complete service can increase the amount of desired content viewed, and reduce the amount of non-desired content viewed, thereby increasing the value of the broadcasts to the viewer and sponsors.

The present invention includes a business model or service which may be sold using a subscription plan in association with devices such as TV, DVR, PVR, etc., that allow the user to be taken or switched to predefined content patterns automatically.

Those skilled in the art will recognize that the invention may be applied to broadcast types that are not limited to traditional television broadcast. For example, the service could monitor web broadcasts that fall into predefined content patterns and automatically switch the user's multimedia viewing software or device, such as Internet broadcasts (e.g. “webcasts”). Those skilled in the art will also recognize that the service can be used to program recording devices to record these segments.

### DETAILED DESCRIPTION OF THE INVENTION

The present invention is divided into three components: (1) a broadcast monitoring center, (2) a method for subscribing devices to be controlled, and (3) method for the user to manage the subscription and provide control parameters. The first component, a monitoring center, may include automated and manual monitoring of broadcasts and their content. The second component, the method for controlling subscribing devices, includes a method and technology for communicating monitoring results from the monitoring center to the subscribing devices.

The third component allows the subscribing component to receive the messages from the monitoring center and to implement channel and signal source changes according to a user's preferences. This third component is especially well suited for implementation in conjunction with or as an enhancement to a DVR unit, and for this reason, we first review the basic functionality and architecture of a DVR.

Digital Video Recorders

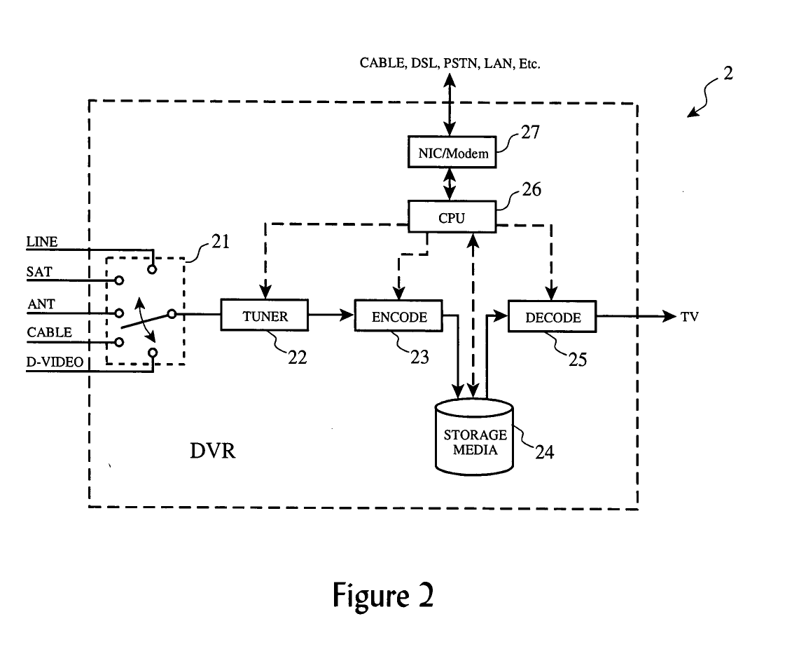

Turning to FIG. 2, a generalized architecture (2) of a DVR unit is shown in which a plurality of signal inputs (e.g. Line, Satellite, Antenna, Cable, Digital Video, etc.) are received into a signal selector switch (21). The selected signal is received by a tuner (22) which decodes a specific “channel” or content stream from the selected signal.

The decoded content stream or channel is then encoded (23) into a digital format (or transcoded from one digital format to another digital format), suitable for digital recording onto a storage media (24), such as a hard disk drive, writeable DVD (CD-R or CD-RW), or memory (e.g. RAM, ROM, Flash memory, etc.). In current DVR systems, the encoder conforms with a Motion Picture Engineers Group (“MPEG”) encoding scheme, and essentially produces data files for writing to the storage media (24).

Simultaneously, or with some amount of delay under user control, the recorded content is retrieved from the storage media (24), and decoded (25) into a signal format which can be output to a television, monitor and/or sound system. This output signal format may be a proprietary format, or may be one of many available “standard” signal formats including, but not limited to, a modulated channel (e.g. channel 3 or 4 in North America), a “line level” signal, an S-Video signal, or a digital video signal (e.g. optical).

A central processing unit (“CPU”) (26) is provided to control all of the components of the DVR. According to the present invention, a DVR is provided also with a means for data communication, such as a Network Interface Card (“NIC”) or modem (27) to allow the CPU to send and receive data messages such as Internet Protocol (“IP”) messages from a cable modem, DSL line, telephone line, local area network (“LAN”), or the like.

Broadcast Monitoring Center

The Broadcast Monitoring Center includes one or more of the following: (a) a staffed central facility, (b) a distributed staffed monitoring organization, and (c) an automated monitoring server, which are responsible for watching broadcasts and registering content changes as they happen into the Update Service.

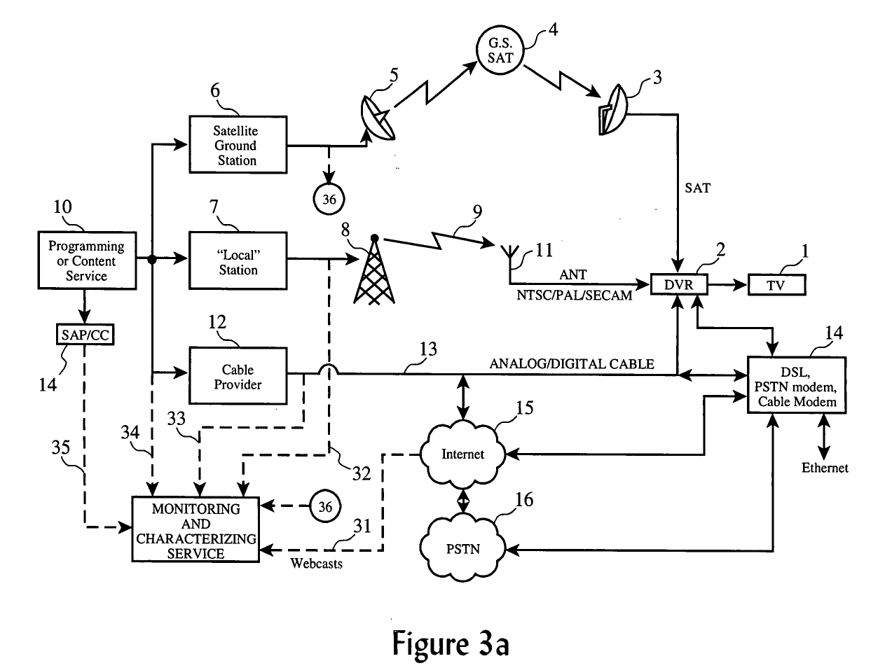

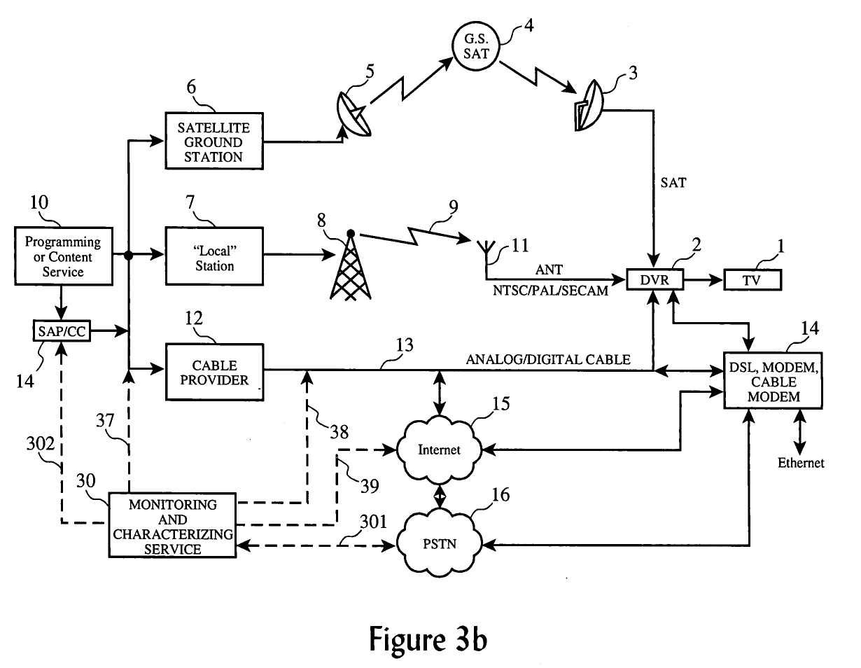

Turning to FIG. 3a, the monitoring and characterizing service (30) is arranged preferably to receive programming and content (10), optionally including SAP or CC, from the variety of sources of content and broadcast content, including but not limited to receiving TV programs (34, 35), cable programs (33), local off-air programs (32), satellite broadcasts (36), and webcasts (31). These programs and broadcasts can be received directly from the program providers, or may be received by subscribing to the broadcasts just as a consumer would do (e.g. using a satellite receiver, antenna, cable converter, etc.).

As shown in FIG. 3b, the monitoring service (300) is preferably, but not necessarily configured, to transmit messages via broadcast signals or the Internet (301, 38, 39, 37, 302) for reception by subscribers of the channel switching service of the present invention.

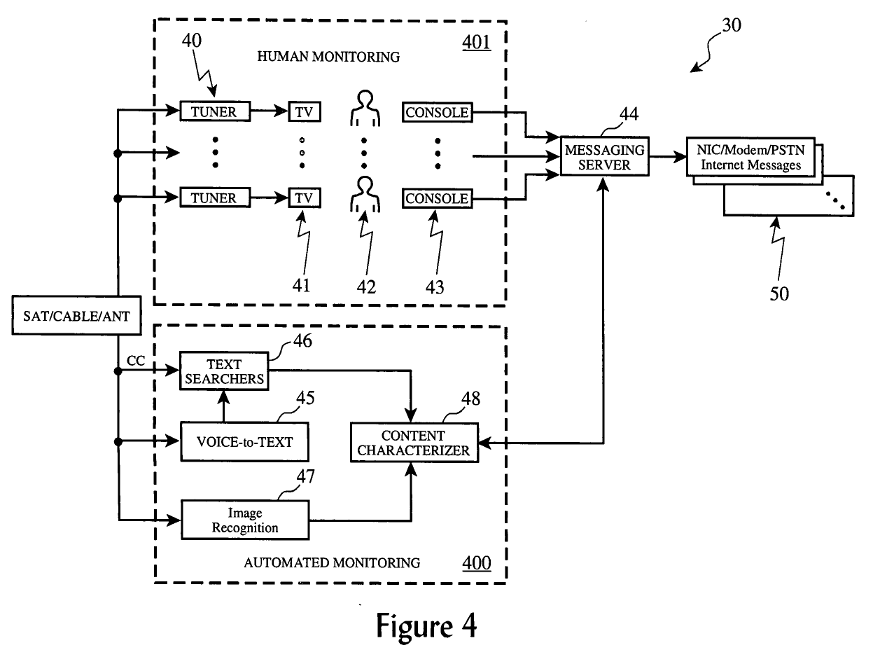

Turning to FIG. 4, two available types of monitoring service (30) are provided by the present invention, either individually or in cooperation, as shown. A centralized or distributed staffed monitoring center (401) is provided with one or more human monitors who receive one or more broadcasts each using suitable reception equipment (40, 41) (e.g. tuners, cable converters, web browser, TV, etc.), and who input their opinions as to the content of each broadcast over time into consoles (43). The human monitors' characterization of each program is received in real-time from the consoles (43) by a message server, which then transmits or broadcasts channel and program characterization messages to the subscribers of the present invention service via appropriate networking interfaces (50) (e.g. NIC, PSTN modem, cable modem, DSL, etc.).

The second type of monitoring of content and broadcasts includes automated characterization (400) of programs in real-time, using text searchers (46) of Closed Captions for programs or recognized voice phrases (45) from the primary or secondary audio programs, and optionally employing image recognizers (47) to characterize (48) content based on the pictures or video portion of programs. Text searching, voice recognition and image recognition technologies are well known in the art, and are employed by the present invention in this manner to realize an automated monitoring service (400), which generates characterization messages via the messaging server (44) similarly to the human monitoring service.

FIG. 4 illustrates the human and automated monitoring service working in parallel to each other, independently of each other. It will be recognized by those skilled in the art, however, that alternate combinations and arrangements may be made within the scope of the present invention, such as arranging the automated recognition to “pre-process” or generate a preliminary characterization which is then reviewed and confirmed by human monitors (e.g. serial configuration vs. parallel configuration). It will also be recognized that either type of monitoring may be provided, without the other type, and still some benefit of the invention can be enjoyed.

Certain content changes may be automated such as the detection of commercials, credits, the start and end of programs, and even image recognition (especially if a certain content type on a specific channel always contains an image or collection of images). Not all channels will require active monitoring. For example, when a movie is playing, it does not lend itself to content pattern usage except in the automated realm of commercial detection.

Monitor Update Service

The Monitor Update Service is the component of the invention that provides content change notification to devices, and preferably is a tiered architecture. A central repository that the Broadcast Monitoring Center updates contains all current content patterns. No legacy data is required except for measurement purposes. Distributed repositories manage subscriptions, including which users are currently subscribing to which content patterns. For example, one repository may notify devices subscribed to the “baseball action” package or a derivative of it, keeping in mind that it is possible for a user to set order of granular preferences for criteria like teams.

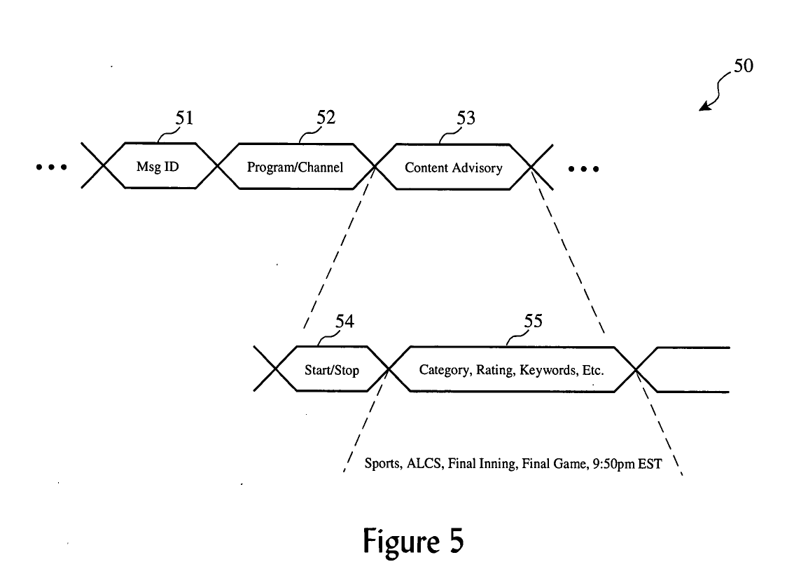

Turning to FIG. 5, an example characterization message (50) is shown, in which a message ID (51), program and channel indicator (52) and content advisory (53) are contained. Each characterization message defines a “short segment content pattern”. The content advisory preferably includes a program start or stop indicator (54) and one or more category indicators (e.g. sports, news, drama, comedy, suspense, game, paid programming, commercial, etc.), ratings (e.g. breaking, adult, family, etc.), and keywords (e.g. “final pitch”, “Dallas Stars hockey”, “American League Championship Series”, “election update”, “series finale”, “financial news”, etc.). A message such as this or having the same informational purpose is created by the monitors and transmitted via the messaging servers to the subscribing devices, such as the enhanced DVR units as previously described.

These characterization messages may be sent as metadata in broadcast signals, over dedicated phone lines, or over networks. Since all commands consist of just command and channel codes, the actual bandwidth consumed is minute. Very little bandwidth and processing is required to issue POP3 commands, and in some available embodiments, the invention service does not even require response confirmation of the messages.

In an alternative embodiment, these characterization messages are not transmitted in real-time as they are generated by the monitors, but instead are stored in a manner accessible by the subscribing devices upon query by the subscribing devices, such as on a web server in a database.

Device Control and Management

The subscribing devices (“SD”) require certain logic to allow channel switching based on received characterization messages. SD either receive notification commands as part of a “push” from the Monitor Update Service, or request commands on a frequent basis from a repository of characterization advisory messages such as by making a database query to a web server.

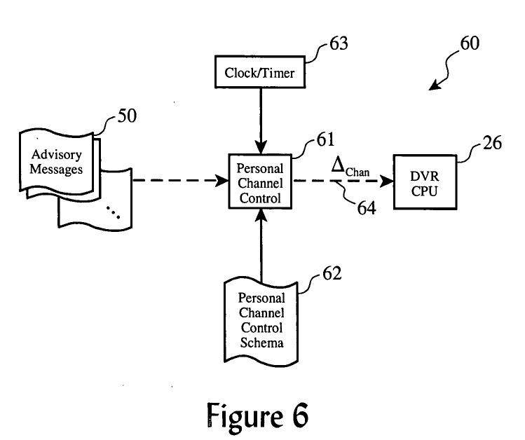

FIG. 6 depicts the logical process (60) for controlling the DVR. In one available embodiment, all of the logic shown is implemented in firmware or circuitry in an enhanced DVR, and the advisory messages are received by the DVR from the monitoring service. In another available embodiment, a portion of the logic shown in FIG. 6 is performed by a remote resource, such as a web server, and only the change-channel commands (64) are sent to the DVR, which requires minimal changes to the DVR design to realize.

In either case, the logic of FIG. 6 includes reception of or retrieval of advisory messages (50) over time by a personal channel controller (61), which also has access to a clock or timer (63). A personal channel control schema (62) contains a user's preferences, is disposed in a manner accessible to the personal channel controller (61). For example, in one embodiment, the user may configure a DVR-stored control schema (62) using on-screen prompts and menus, and in another available embodiment, a user may configure a web-based control schema (62) using a web browser, WebTV system, or the like. Table 1 shows an example personal channel control schema for a certain user.

TABLE 1
Example Personal Channel Control Schema

highest_preference: ALCS final game, final pitch
medium_reference: breaking news, political debates
lowest_preference: NASCAR, final lap, sports scores roundup summary

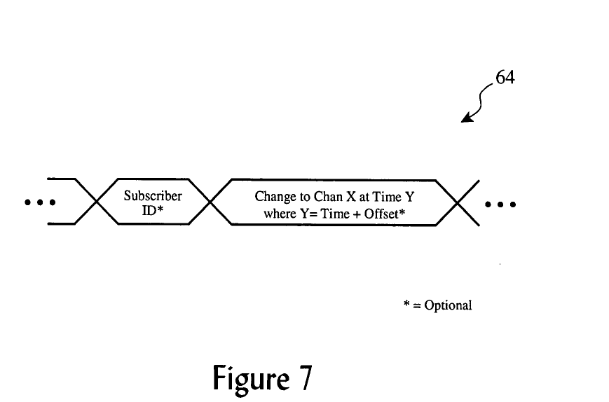

As the advisory messages (50) are received, they are evaluated against the personal channel control schema (62), and if appropriate, a change-channel (64) command is issued to the DVR CPU (26). The change-channel (64) command may also include a source indication, such as DirectTV satellite, ESPN2 on cable, channel 10 off-air antenna, etc., and may optionally include a time and/or delay offset value at which the programming characterization will take effect (or took effect), as shown in FIG. 7.

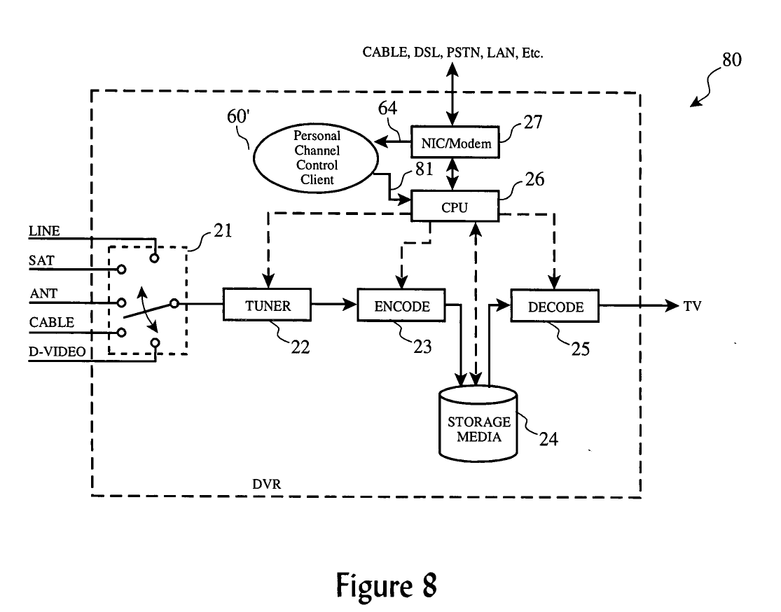

FIG. 8 shows a modification of the generalized architecture of a DVR in which some or all of the personal channel control logic (60′) has been implemented, such that the DVR's CPU can be commanded to change signal sources, channels, etc.

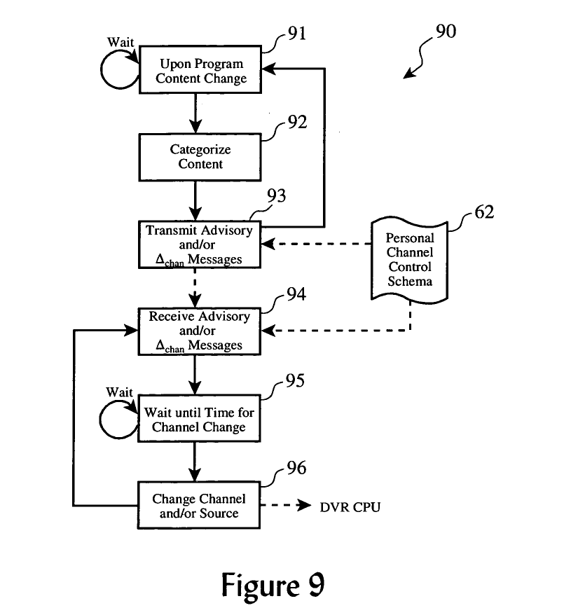

FIG. 9 provides more details of the logical process (90) of controlling a broadcast receiver according to the present invention. When the content of a program changes (91), that content is categorized and characterized (92) by the monitoring service(s), and an advisory is either transmitted or created and stored (93). Alternatively, change-channel commands are generated by the update service according to each subscriber's personal channel control schema (62), as previously described in an alternate embodiment.

When the broadcast receiver (e.g. enhanced DVR, enhanced HDTV receiver, etc.); receives (94) either an advisory (first embodiment) or change-channel command (alternate embodiment), the receiver may wait if appropriate according to the time and/or offset indicators in the message, and then changes the channel and optionally changes the signal source (96) accordingly.

Latency, Delay, and Synchronization of Content and Advisories

One potentially problematic factor in the quality of the service of the invention is possible latency from Broadcast Monitoring Center registry, to Update Service distribution, to transmission or reception to local devices. According to enhanced embodiments of the present invention, intelligence is provided in the system, such as local detection of commercials that can then alter channels to one of the other channel codes within the subscription as it awaits commands. Even with complete network or transmission outage, there can still be value in the ability to manually toggle between the channels that were part of the last subscription, such as a dynamically created channel favorites list that comes from the service.

Subscription Management

The management of subscriptions is preferably accomplished using a web page on a web server, or alternatively using a Voice Response Unit (“VRU”) via telephone. Still another embodiment option provides integrated controls into the remote control device of the DVR (e.g. buttons or keys which allow quick definition of control schema).

Ultimately, according to the preferred embodiment, the service provider controls how granular the user's preferences may be defined. To reduce cost, yet limit functionality, the service may provide set subscriptions without customization, such as preference templates. For example, a service provider could provide for a limited time a “Baseball championship fanatic” template which sets baseball events as a highest priority, or a “Political Season Pundit” template which sets breaking political news as a highest priority.

### CONCLUSION

Certain embodiment details and examples have been provided in order to describe and illustrate the invention. It will be recognized by those skilled in the art that these examples do not define the only available configurations and realizations of the invention, and that the scope of the present invention should be determined by the following claims.

What is claimed is:

1. A system for automatically controlling a broadcast receiver, comprising:
a plurality of broadcast content monitors that generate broadcast advisory messages upon change in broadcast content for one or more broadcast channels;
a personal channel control schema including definitions of a user's preferences for broadcast content reception; and
a channel change commander configured to receive said advisory messages, evaluate advisory messages against said personal channel control schema, and to issue commands to a broadcast receiver to change channel, change signal source, or both, in accordance with said control schema.

2. The system as set forth in claim 1 further comprising a transmission media for transmitting said advisory messages from a monitoring center to one or more subscribing broadcast receiver devices.

3. The system as set forth in claim 1 further comprising a transmission media for transmitting said commands from an update service to one or more subscribing broadcast receiver devices.

4. The system as set forth in claim 1 further comprising keywords disposed in said personal channel control schema, and wherein said channel change commander is further configured to search said advisory messages for content of keywords and to command changes in channel, signal source, or both, upon finding said keywords.

5. The system as set forth in claim 1 wherein said broadcast content monitors comprise at least one element from the group of a human monitor using a broadcast receiver and advisory message generator, a text keyword searcher for searching a closed caption signal associated with a program, a text keyword searcher for searching the output of a voice recognizer configured to recognize words in an audio signal portion of a program, and an image recognizer configured to recognized images in a visual signal portion of a program.

6. The system as set forth in claim 1 wherein said channel and signal source change commands comprise a time to change indicator.

7. The system as set forth in claim 6 wherein said time to change indicator comprises an indicator selected from the group of an absolute time to change, a relative time to change, and an offset time to change.

8. The system as set forth in claim 1 wherein said advisory messages are stored for later retrieval upon query by said channel change commander

9. A method for automatically controlling a broadcast receiver, comprising the steps of:
generating broadcast advisory messages by a plurality of broadcast content monitors responsive to changes in broadcast content for one or more broadcast channels;
providing a personal channel control schema including definitions of a user's preferences for broadcast content reception;
evaluating said advisory messages against said personal channel control schema; and
issuing commands to a broadcast receiver to change channel, change signal source, or both, in accordance with said control schema.

10. The method as set forth in claim 9 further comprising transmitting said advisory messages from a monitoring center to one or more subscribing broadcast receiver devices.

11. The method as set forth in claim 9 further comprising transmitting said commands from an update service to one or more subscribing broadcast receiver devices.

12. The method as set forth in claim 9 further comprising:
disposing one or more keywords in said personal channel control schema;
searching said advisory messages for content of keywords; and
commanding changes in channel, signal source, or both, upon finding said keywords.

13. The method as set forth in claim 9 further comprises a step selected from the group of providing a human monitor with a broadcast receiver and an advisory message generator, searching a closed caption signal associated with a program using a text searcher, searching the output of a voice recognizer configured to recognize words in an audio signal portion of a program using a text searcher, and recognizing an image in a visual signal portion of a program.

14. The method as set forth in claim 9 further comprise providing a time to change indicator in association with said channel change command.

15. The method as set forth in claim 14 wherein said time to change indicator comprises an indicator selected from the group of an absolute time to change, a relative time to change, and an offset time to change.

16. The method as set forth in claim 9 further comprising storing said advisory messages for later retrieval upon query by said channel change commander.

17. A computer readable medium encoded with software for automatically controlling a broadcast receiver, the software performing the steps of:
generating broadcast advisory messages by a plurality of broadcast content monitors responsive to changes in broadcast content for one or more broadcast channels;
providing a personal channel control schema including definitions of a user's preferences for broadcast content reception;
evaluating said advisory messages against said personal channel control schema; and
issuing commands to a broadcast receiver to change channel, change signal source, or both, in accordance with said control schema.

18. The medium as set forth in claim 17 further comprising software for transmitting said advisory messages from a monitoring center to one or more subscribing broadcast receiver devices.

19. The medium as set forth in claim 17 further comprising software for transmitting said commands from an update service to one or more subscribing broadcast receiver devices.

20. The medium as set forth in claim 17 further comprising software for:
disposing one or more keywords in said personal channel control schema;
searching said advisory messages for content of keywords; and
commanding changes in channel, signal source, or both, upon finding said keywords.

21. The medium as set forth in claim 17 further comprising software for performing a step selected from the group of providing a human monitor with a broadcast receiver and an advisory message generator, searching a closed caption signal associated with a program using a text searcher, searching the output of a voice recognizer configured to recognize words in an audio signal portion of a program using a text searcher, and recognizing an image in a visual signal portion of a program.

22. The medium as set forth in claim 17 further comprising software for providing a time to change indicator in association with said channel change command.

23. The method as set forth in claim 22 wherein said time to change indicator comprises an indicator selected from the group of an absolute time to change, a relative time to change, and an offset time to change.

24. The medium as set forth in claim 17 further comprising software for storing said advisory messages for later retrieval upon query by said channel change commander.

25. A method for providing an personal channel change service comprising the steps of:
establishing a subscription to a channel change service to a subscribing broadcast receiver, and a personal channel change schema containing preferences for content reception by a subscriber;
characterizing over time the content of a plurality of channels by monitoring the broadcasts of said channels;
evaluating over time said characterization of said channel content with respect to said personal channel change schema; and
issuing a channel change command to said subscribing broadcast receiver responsive to maintaining a maximized correlation between said change schema and channel content which said subscriber is receiving at any given time.

26. The method as set forth in claim 25 further comprising providing an enhanced broadcast receiver configured to receive messages containing said channel content characterization, and to implement said channel change commands.

27. The method as set forth in claim 25 further comprising providing an enhanced broadcast receiver configured to receive channel change commands containing said at least one indicator selected from the group of a channel to receive, a signal source to receive, an absolute time at which to make a channel change, a relative time at which to make a change, and an offset time value at which time to make a change.

28. The method as set forth in claim 25 wherein said step of establishing a personal channel control schema comprises providing a template channel control schema.

29. The method as set forth in claim 25 wherein said step of establishing a personal channel control schema comprises providing a user interface to a control schema editor.

30. The method as set forth in claim 29 wherein said user interface comprises one or more menus or prompts provided on the screen of a video monitor.

31. The method as set forth in claim 29 wherein said user interface comprises one or more menus or prompts provided on a web page.
